(19) United States
(12) Patent Application Publication
(10) Pub. No.: US 2008/0219318 A1
(43) Pub. Date: Sep. 11, 2008

(54) Mirror with non-invasive temperature sensing device

(76) Inventor: Chi Yau Yue, (US)

Correspondence Address: ERIC HANSCOM, 7395 PORTAGE WAY, CARLSBAD, CA, 92011, US

(21) Appl. No.: 11/713,752

(22) Filed: Mar. 5, 2007

(51) Int. Cl. G01J 5/02

(52) U.S. Cl. 374/121

(57) ABSTRACT

The embodiments of the invention provide a non-invasive temperature sensing device including a glass mirror and a temperature sensing device coupled to the glass mirror such that when a user is positioned in front of the glass mirror the temperature sensing device can sense the body temperature of the person. The temperature sensing device can be an infrared or laser thermometer. The device can include a base having an upright member coupled thereto, wherein the glass mirror is coupled to the upright member. The glass mirror can further include a temperature display coupled thereto. The device can also contain a processor and memory for processing and storing sensed temperatures. The temperature sensing device can alternatively be attached to either the base or the upright member. More than one temperature sensing device can be connected to the device.

### BACKGROUND

1. Field of the Embodiments of the Invention

The embodiments of the invention relate to the field of thermal measuring and testing devices. More specifically, the embodiments of the present invention relate to a non-invasive temperature sensing device.

2. Description of the Related Art

Thermometers are one of the most often used devices in medical offices, as an increase or decrease in body temperature is often a reliable predictor of illness. Many thermometers are invasive, meaning that they must come into contact with a person's body in order to accurately measure the person's body temperature. Recently, thermometers have been developed that do not require contact with a person's body in order to accurately measure one's body temperature. As with traditional thermometers, the non-invasive thermometers have typically taken the form of handheld devices that must be pointed at a person by a nurse or physician. While these thermometers may be effective, the portable nature of the thermometer presents the problem that the thermometer could easily be misplaced or lost within a doctor's office or other crowded setting. Therefore, a need exists for a non-invasive thermometer that overcomes this disadvantage.

Embedding the thermometer into or onto a standard mirror is the preferred embodiment of this invention. Almost all bathrooms have one or more mirrors resting on stand apparatus on the countertops. Many women use such mirrors to apply makeup and check their appearance. Men often use such mirrors for shaving. Such mirrors are also frequently found on dressers and other furniture associated with bedrooms. As such, a conventional mirror which provides the non-invasive temperature sensing capabilities as described in this application supplies an important improvement in the art.

In this respect, before explaining at least one embodiment of the invention in detail it is to be understood that the embodiments of the invention are not limited in their application to the details of construction and to the arrangement of the components set forth in the following description or illustrated in the drawings. The embodiments of the invention are capable of being practiced and carried out in various ways. In addition, it is to be understood that the phraseology and terminology employed herein are for the purpose of description and should not be regarded as limiting.

### BRIEF SUMMARY OF INVENTION

One embodiment of the invention provides a non-invasive temperature sensing device. The device includes a glass mirror and a temperature sensing device coupled to the glass mirror such that when a user is positioned in front of the glass mirror the temperature sensing device can sense the body temperature of the person. The temperature sensing device can be an infrared or laser thermometer. The temperature sensing device can be located anywhere along or within the glass mirror.

In another embodiment, the temperature sensing device can include a base having an upright member coupled thereto, wherein the glass mirror is coupled to the upright member. The temperature sensing device can be coupled to the glass mirror, to the upright member, or to the base. In other embodiments, the device can include multiple temperature sensing devices that can be attached to either/or the glass mirror, the upright member, or the base.

In another embodiment, the glass mirror can further include a temperature display coupled thereto. The temperature display can be a digital display. In another embodiment, the device can contain at least one memory module for storing at least one sensed temperature value. In another embodiment, the device may also contain a time display coupled thereto. The time display can be coupled to the base, the upright member, or to the glass mirror. The device can contain circuitry therein for controlling the temperature sensing device, the temperature display, and/or the time display.

There has thus been outlined, rather broadly, features of some of the embodiments of the invention in order that the detailed description thereof may be better understood, and in order that the present contribution to the art may be better appreciated.

### BRIEF DESCRIPTION OF THE DRAWINGS

The accompanying drawings, which are incorporated in and form a part of this specification, illustrate embodiments of the invention and together with the description, serve to explain the principals of some of the embodiments of the invention.

FIG. 1 shows a front perspective view of an embodiment of the mirror with non-invasive temperature sensing device.

FIG. 2 shows a side view of an embodiment of the mirror with non-invasive temperature sensing device.

FIG. 3 shows a side view of an embodiment of the mirror with non-invasive temperature sensing device, wherein the device is taking the temperature of a user.

FIG. 4 shows a front perspective view of another embodiment of the mirror with non-invasive temperature sensing device.

FIG. 5 shows a front perspective view of another embodiment of the mirror with non-invasive temperature sensing device having a time display.

FIG. 6 shows a block diagram of the circuitry contained within an embodiment of the mirror with non-invasive temperature sensing device.

FIG. 7 shows a front perspective view of yet another embodiment of the mirror with non-invasive temperature sensing device.

FIG. 8 shows a side view of yet another embodiment of the mirror with non-invasive temperature sensing device.

FIG. 9 shows a side view of yet another embodiment of the mirror with non-invasive temperature sensing device, illustrating the angular rotation capabilities of the device.

### DETAILED DESCRIPTION OF THE INVENTION

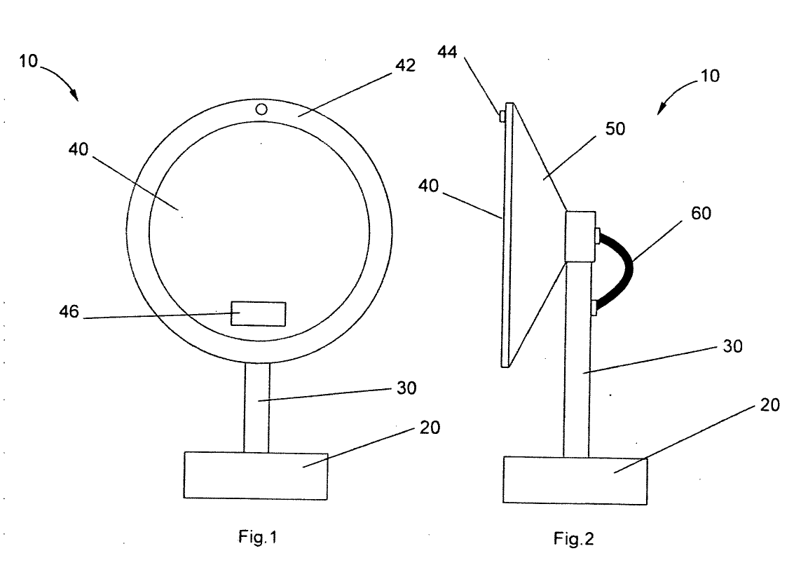

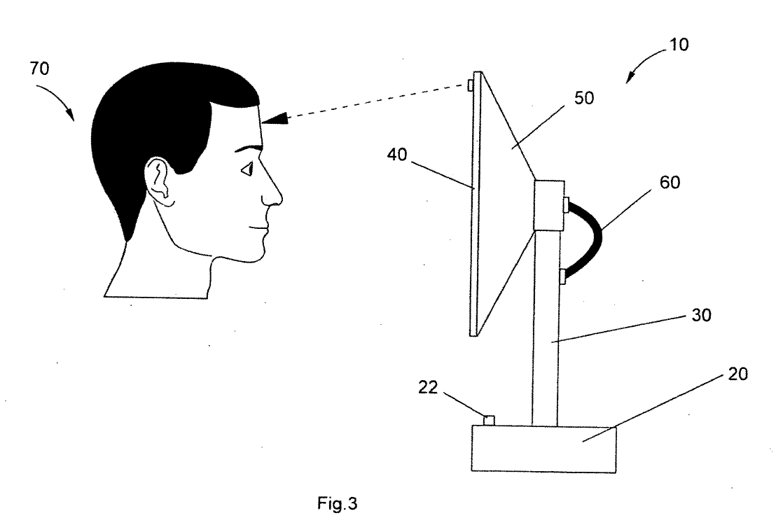

Referring now to the drawings, wherein similar parts are identified by like reference numerals, FIG. 1 shows a front perspective view of an embodiment of the mirror with non-invasive temperature sensing device 10. Device 10 includes a base 20, an upright member 30, and a mirror 40. Base 20 and upright member 30 can both comprise various shapes and sizes depending on the application and design of device 10, as well as be fabricated from various materials such as metal and polymer-based materials. Mirror 40 can contain a panel 42 surrounding its perimeter to secure mirror 40 to a connector portion 50 (see FIG. 2). Mirror 40 can vary in both shape and size to suit particular applications.

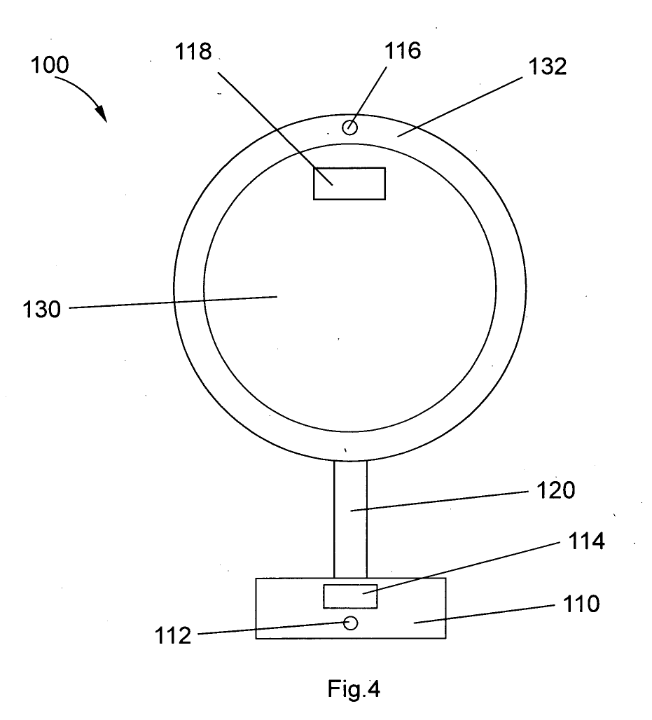

Device 10 includes a temperature sensing device 44 coupled thereto. Temperature sensing device 44 is preferably a non-invasive device, such as an infrared or laser thermometer. However, other non-invasive temperature sensing devices can be utilized, as would be recognized by one with ordinary skill in the art. Temperature sensing device 44 can be located anywhere on or within device 10, including but not limited to on or within base 20, upright member 30, or mirror 40. Further, more than one temperature sensing device 44 may be located within device 10 (see FIG. 4), with the additional temperature sensing device(s) 44 additionally having the capability to be located anywhere on or within device 10. Temperature sensing device 44 may be battery powered, solar powered, or may be powered by an electrical outlet. Device 10 may include multiple temperature sensing devices 44 to accommodate more than one user at the same time. Temperature sensing device 44 may be secured to device 10 in various ways including but not limited to gluing, pressing, snapping, and magnetic attraction. Temperature sensing device 44 may also be removably attached to device 10.

Device 10 also can include a temperature display 46 coupled thereto. Temperature display 46 displays the temperature sensed by temperature sensing device 44. Temperature display 46 can comprise a digital display such as a liquid crystal display, plasma display, array of light-emitting diodes, or other type of display that can convey temperature information to a user. Alternatively, temperature display 46 may convey a color scheme based on a range of sensed temperatures. For example, temperature display 46 may display the color red to indicate a very high temperature, green to indicate a normal temperature, and blue to indicate a very low temperature. Temperature display 46 can vary in size, shape, and placement on device 10. For example, temperature display 46 can be positioned on base 20, upright member 30, and/or mirror 40. Device 10 may include multiple temperature displays 46 to accommodate more than one user at the same time.

FIG. 2 shows a side view of non-invasive temperature sensing device 10, including base 20, upright member 30, mirror 40, and connector portion 50. Connector portion 50 can comprise various sizes and shapes depending on the application and design of device 10. Device 10 can include a cord 60 attached thereto. Cord 60 can supply power to temperature sensing device 44 and/or temperature display 46.

FIG. 3 shows a side view of an embodiment of the mirror with non-invasive temperature sensing device 10, wherein device 10 is taking the temperature of a user. To utilize one embodiment of device 10, a user 70 stands in front of mirror 40 and temperature sensing device 44 automatically senses the temperature of the user 70. In another embodiment, a user 70 can press a button 22, which is shown here on base 20 for illustration, to signal that temperature sensing device 44 can begin to sense the temperature of the user 70. Temperature sensing device 44 can be programmed to sense the temperature of an individual for a duration that is depend on how accurate of a measurement is desired. For example, if a high accuracy rate is desired, temperature sensing device 44 can be programmed to sense the temperature of a user 70 for twenty seconds. If less accuracy is desired, temperature sensing device 44 can sense the temperature of a user 70 for five seconds. Temperature sensing device 44 preferably senses the temperature of a user 70 at the forehead of the user 70. However, temperature sensing device 44 can be positioned and programmed to sense temperature from other body areas.

FIG. 4 shows a front perspective view of another embodiment of the mirror with non-invasive temperature sensing device 100. Device 100 includes a base 110, an upright member 120, and a mirror 130. Base 110 and upright member 120 can both comprise various shapes and sizes depending on the application and design of device 100, as well as be fabricated from various materials such as metal and polymer-based materials. Mirror 130 can contain a panel 132 surrounding its perimeter to secure mirror 130 to a connector portion (not shown). Mirror 130 can be similar in design to mirror 40 of device 10. Device 100 also includes temperature sensing devices 112 and 116 coupled thereto. More than one temperature sensing device can allow more than one user to use device 100 at the same time. Device 100 also includes temperature displays 114 and 118 that can each be tied to temperature sensing devices 112 and 116 respectively, to show the respective temperatures sensed. It is to be recognized that temperature sensing devices 112 and 116 and temperature displays 114 and 118 can be positioned anywhere along or within device 100 and still remain within the scope of the embodiments of this invention. Also, device 100 is not limited in the number of temperature sensing devices or temperature displays that can be located on or therein.

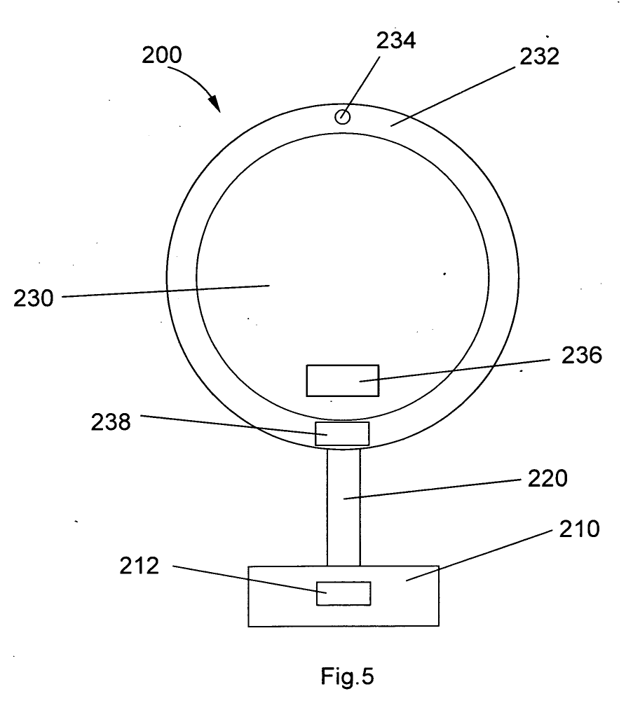

FIG. 5 shows a front perspective view of another embodiment of the mirror with non-invasive temperature sensing device 200. Device 200 includes a base 210, an upright member 220, and a mirror 230. Base 210 and upright member 220 can both comprise various shapes and sizes depending on the application and design of device 200, as well as be fabricated from various materials such as metal and polymer-based materials. Mirror 230 can contain a panel 232 surrounding its perimeter to secure mirror 230 to a connector portion (not shown). Mirror 230 can be similar in design to mirror 40 of device 10. Device 200 also includes a temperature sensing device 234 that can be similar to temperature sensing device 44 of device 10. Device 200 also includes a temperature display 236 located thereon. Temperature display 236 can be similar to temperature display 46 of device 10. Device 200 also includes a time display 212. Time display 212 is shown on base 210, but can be located anywhere on or within device 200. Time display 212 can be either an analog or digital display, and can be battery powered, solar powered, or powered by an electrical outlet. Device 200 can also include a sensor with associated display 238 for monitoring the ambient temperature around device 200.

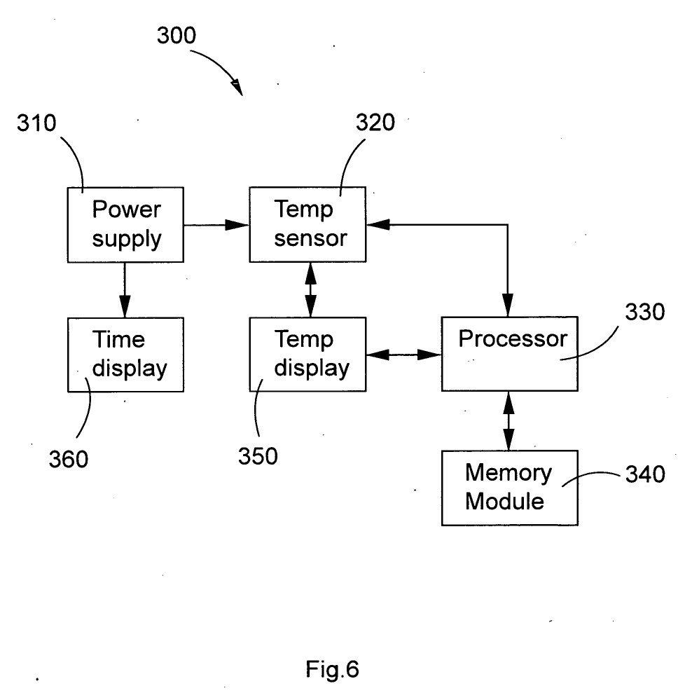

FIG. 6 shows a block diagram of the circuitry 300 contained within an embodiment of the mirror with non-invasive temperature sensing device. Circuitry elements can include a power supply 310, a temperature sensor 320, a processor 330, one or more memory modules 340, a temperature display 350, and a time display 360. Power supply 310 can be connected to temperature sensor-320 and time display 360, as well as other circuitry elements as desired. Temperature sensor 320 is preferably connected to temperature display 350 such that a sensed temperature can be displayed on temperature display 350. A processor 330 can be connected to temperature sensor 320, temperature display 350, and memory module 350 to provide the ability to process, store, and retrieve temperatures sensed and/or displayed. One benefit of such an arrangement is to allow a user to be able to track sensed temperatures over a period of time. Processor 330 can contain various software to allow various features to be implemented into the embodiments of the mirror with non-invasive temperature sensing device.

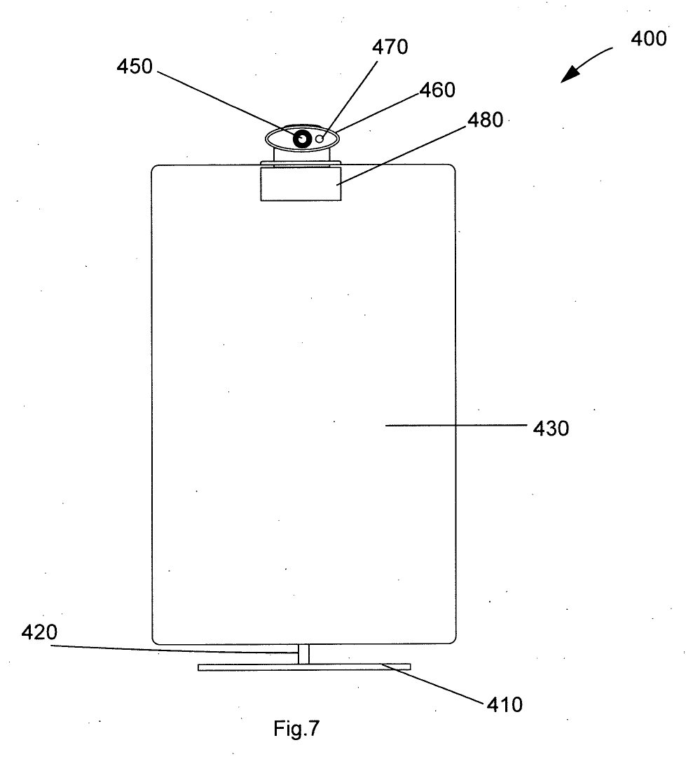

FIG. 7 shows a front perspective view of yet another embodiment of the mirror with non-invasive temperature sensing device 400. Device 400 includes a base 410, an upright member 420, and a mirror 430. Base 410 and upright member 420 can both comprise various shapes and sizes depending on the application and design of device 400, as well as be fabricated from various materials such as metal and polymer-based materials. Mirror 430 can be similar in design to mirror 40 of device 10. Mirror 430 can be connected to upright member 420 by connector portion 440. Device 400 also includes a temperature sensing device 450 coupled thereto. Temperature sensing device 450 can be coupled to a support member 460. Support member 460 can be secured to mirror 430 or to connector portion 440.

Support member 460 can include an indicator light 470 coupled thereto. Indicator light 470 can be used to identify to a user the desired temperature sensing location. For example, if indicator light 470 is green, this can indicate that temperature sensing device 450 will sense the temperature of a user from the user's forehead. If indicator light 470 is blue, this can indicate that temperature sensing device 450 will sense the temperature of a user from another location of the user's ear or other body region. Device 400 also includes a temperature display 480 that is tied to temperature sensing device 450, to show the sensed temperature. It is to be recognized that temperature sensing device 450 and temperature display 480 can be positioned anywhere along or within device 400 and still remain within the scope of the embodiments of this invention.

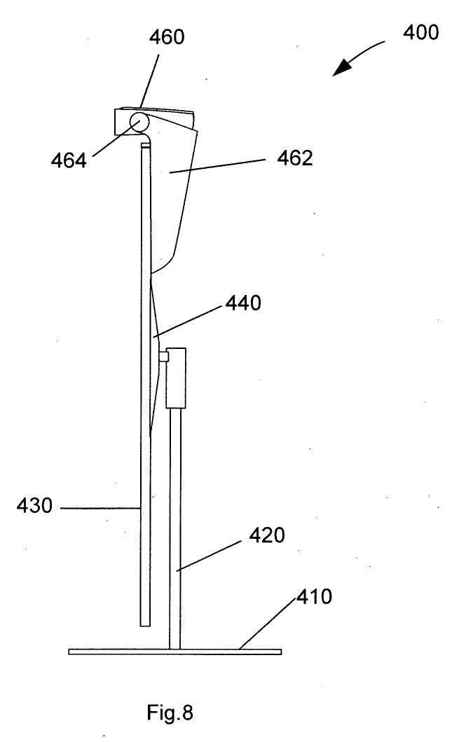

Referring to FIG. 8, there is shown a side view of device 400. This view illustrates the attachment of mirror 430 to upright member 420 via connector portion 440. This view also illustrates the attachment of support member 460 to mirror 430 via attachment member 462. Support member 460 and attachment member 462 can be rotatably secured to one another such that support member 460 can pivot with respect to attachment member 462. This enables support member 460 to be adjusted so temperature sensing device 450 can be positioned to sense temperature from various body parts. Device 400 also includes a button 464 that can be coupled to attachment portion 462. Button 464 can be used by a user to select a desired temperature sensing area, to initiate a temperature sensing sequence, or both. If button 464 is a multi-functional button, a user can choose between features by pressing and holding the button for various time intervals or by merely pressing and releasing button 464. To have their temperature sensed, a user can press button 464 once to set the location and then again to initiate the temperature sensing function. At this point, user feedback, such as an audible signal or a flash of light indicator 470, can indicate that the user's temperature has been taken or is being taken. After the temperature is sensed, the result can appear on temperature display 480.

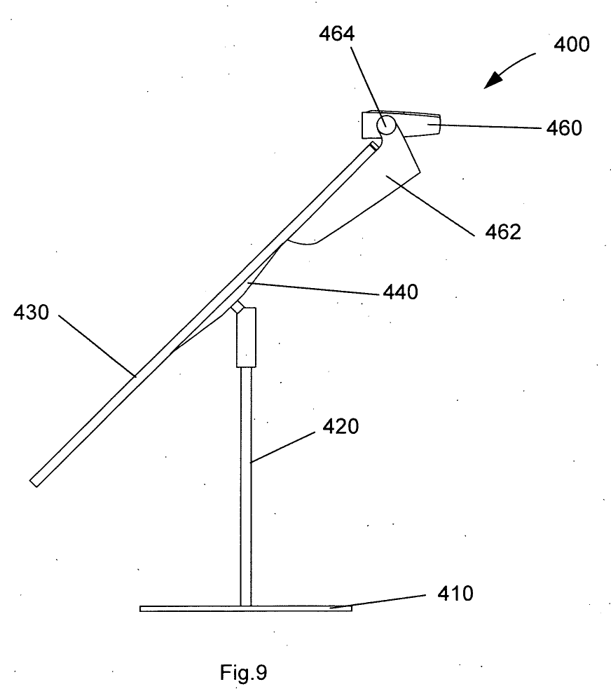

FIG. 9 shows a side view of device 400. This figure illustrates the angular rotation capabilities of mirror 430, along with the attached support member 460, in relation to upright member 420. This rotational capability, combined with the capability of support member 460 to pivot in relation to attachment member 462, provides the user the ability to adjust device 400 so that the user can position temperature sensing device 450 to sense the user's temperature at various regions of the user's body. Mirror 430 is capable of rotating any number of degrees with respect to upright member 420 to provide maximum temperature sensing coverage.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

The above description is pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

What is claimed is:

1. A non-invasive temperature sensing device comprising:
a) a glass mirror; and
b) at least one temperature sensing device coupled to the glass mirror
whereby when a user is positioned in front of the glass mirror the at least one temperature sensing device can sense the body temperature of the person.

2. The non-invasive temperature sensing device of claim 1 further comprising at least one temperature display coupled to the glass mirror.

3. The non-invasive temperature sensing device of claim 1 wherein the at least one temperature display is a digital display.

4. The non-invasive temperature sensing device of claim 1 further comprising a base having an upright member coupled thereto, wherein the glass mirror is coupled to the upright member.

5. The non-invasive temperature sensing device of claim 4 further comprising a processor and memory module operatively connected to the at least one temperature sensing device.

6. The non-invasive temperature sensing device of claim 1 further comprising a means for activating the operation of the at least one temperature sensing device operatively coupled to the at least one temperature sensing device.

7. The non-invasive temperature sensing device of claim 6, further comprising a base having an upright member coupled thereto, wherein the means for activating the operation of the at least one temperature sensing device is coupled to the base.

8. The non-invasive temperature sensing device of claim 1, wherein the temperature sensing device is an infrared thermometer.

9. The non-invasive temperature sensing device of claim 1 further comprising a light indicator coupled to the glass mirror for providing user feedback.

10. The non-invasive temperature sensing device of claim 1 further comprising a time display coupled to the glass mirror.

11. The non-invasive temperature sensing device of claim 1 further comprising memory operatively connected to the temperature sensing device for storing at least one temperature value.

12. The non-invasive temperature sensing device of claim 11 further comprising a base having an upright member coupled thereto, wherein the glass mirror is coupled to the upright member and the memory is housed within in the base.

13. The non-invasive temperature sensing device of claim 1 further comprising means for sensing ambient temperature coupled to the glass mirror.

14. A non-invasive temperature sensing device comprising:
a) a glass mirror;
b) at least one temperature sensing device coupled to the glass mirror; and
c) a temperature display coupled to the glass mirror
whereby when a user is positioned in front of the glass mirror the at least one temperature sensing device can sense the body temperature of the person and the sensed temperature can be displayed on the temperature display.

15. The non-invasive temperature sensing device of claim 14, wherein the at least one temperature sensing device is an infrared thermometer.

16. The non-invasive temperature sensing device of claim 14 further comprising a base having an upright member coupled thereto, wherein the glass mirror is coupled to the upright member.

17. The non-invasive temperature sensing device of claim 14 further comprising a means for activating the operation of the at least one temperature sensing device operatively coupled to the at least one temperature sensing device.

18. The non-invasive temperature sensing device of claim 14 further comprising memory operatively connected to the at least one temperature sensing device for storing at least one temperature value.

19. A non-invasive temperature sensing device comprising:
a) a base portion;
b) an upright member coupled to the base portion, the upright member having a glass mirror rotatably coupled thereto;
c) an infrared thermometer coupled to the base portion; and
d) a digital temperature display coupled to the glass mirror
whereby when a user is positioned in front of the glass mirror the infrared thermometer can sense the body temperature of the person and the sensed temperature can be displayed on the temperature display.

20. The non-invasive temperature sensing device of claim 19 further comprising a processor and at least one memory module contained within the base, the at least one memory module operatively connected to the temperature sensing device for storing at least one temperature value.
